(19) United States
(12) Patent Application Publication
(10) Pub. No.: US 2025/0044428 A1
(43) Pub. Date: Feb. 6, 2025

(54) DISTANCE MEASURING DEVICE AND ELECTRONIC DEVICE

(71) Applicant: SONY SEMICONDUCTOR SOLUTIONS CORPORATION, KANAGAWA (JP)

(72) Inventor: GOSHI WATANABE, KANAGAWA (JP)

(21) Appl. No.: 18/720,014

(22) PCT Filed: Nov. 8, 2022
(86) PCT No.: PCT/JP2022/041576

§ 371 Date: Jun. 14, 2024

(30) Foreign Application Priority Data
Dec. 23, 2021 (JP) 2021-208901

(51) Int. Cl. G01S 7/4912; G01S 7/4914; G01S 7/4915; G01S 17/32; G01S 17/894

(52) U.S. Cl. CPC G01S 7/4918; G01S 7/4914; G01S 7/4915; G01S 17/32; G01S 17/894

(57) ABSTRACT

A distance measuring device of the present technology includes: a light source that irradiates a measurement object with light of two modulation frequencies; a light detection unit that includes a plurality of pixels and receives reflected light based on the irradiation light of the two modulation frequencies from the light source, the reflected light coming from the measurement object; and an exposure control unit that performs exposure control to obtain a maximum confidence value for a confidence value of the reflected light within a range not exceeding a saturation threshold that serves as a saturation determination reference, with the saturation threshold used as a target, on the basis of a measurement result for each of the two modulation frequencies based on a detection output of the light detection unit. Then, a measurement result for one of the two modulation frequencies is set as a calculation object configured to perform exposure control, and a predetermined margin is set to the saturation threshold with respect to the measurement result for the other modulation frequency.

### TECHNICAL FIELD

The present technology relates to a distance measuring device. Specifically, the present technology relates to a time-of-flight (ToF)-based distance measuring device and an electronic device including the distance measuring device.

### BACKGROUND ART

In the ToF-based distance measuring device, automatic exposure (AE) control of the light source is performed. In this automatic exposure control (AE control), in order to acquire a high-quality distance image (depth map), exposure control is performed so that the maximum confidence value (Confidence) level can be acquired within a range not exceeding a saturation threshold, with the saturation threshold serving as a saturation determination reference as a target (e.g., see Patent Document 1).

### CITATION LIST

### Patent Document

Patent Document 1: Japanese Patent Application Laid-Open No. 2020-139937

### SUMMARY OF THE INVENTION

### Problems to be Solved by the Invention

In the conventional technology described above, the exposure control is performed to obtain the maximum confidence value within a range not exceeding the saturation threshold with the saturation threshold as a target. However, at the time of the exposure control, it is necessary to check whether the confidence value does not exceed the saturation threshold for each pixel of a light detection unit.

In this manner, when it is checked whether the confidence value does not exceed the saturation threshold for each pixel, the calculation time for automatic exposure control may exceed one vertical period in a device with poor (limited) computational resources.

Then, when the calculation time for the automatic exposure control exceeds one vertical period, the exposure control processing is performed only once in a plurality of vertical periods, rather than every vertical period. As a result, a problem arises that the time taken for convergence to the target value extends.

The present technology has been made in view of such a situation, and an object of the present technology is to reduce the calculation time for automatic exposure control so as not to exceed one vertical period.

### Solutions to Problems

The present technology has been made to solve the problems described above, and a first aspect of the present technology is a distance measuring device including: a light source that irradiates a measurement object with light of two modulation frequencies, a light detection unit that includes a plurality of pixels and receives reflected light based on the irradiation light of the two modulation frequencies from the light source, the reflected light coming from the measurement object, and an exposure control unit that performs exposure control to obtain a maximum confidence value for a confidence value of the reflected light within a range not exceeding a saturation threshold that serves as a saturation determination reference, with the saturation threshold used as a target, on the basis of a measurement result for each of the two modulation frequencies based on a detection output of the light detection unit. The exposure control unit sets the measurement result for one of the two modulation frequencies as a calculation object configured to perform exposure control, and sets a predetermined margin to the saturation threshold with respect to the measurement result for the other modulation frequency. As a result, the problem of computational resources can be solved, and the exposure control processing can be performed for each vertical period. This brings about an effect that the convergence time until convergence to the target value can be reduced.

Furthermore, in the first aspect, the one modulation frequency may be a low modulation frequency, and the other modulation frequency may be a high modulation frequency. It is thus possible to obtain a large signal, particularly in a case where distance measurement is performed on a measurement object existing at a short distance. This brings about an effect that a wide measurement range without ambiguity can be achieved.

Furthermore, in the first aspect, the exposure control unit has a first mode in which the calculation object for performing the exposure control is limited to the low modulation frequency and a predetermined margin is provided in the saturation threshold with respect to a measurement result for the high modulation frequency, and a second mode in which the exposure control is performed, setting the saturation threshold without a margin as a target and setting each of the low modulation frequency and the high modulation frequency as the calculation object for performing the exposure control. The exposure control unit selectively uses the first mode and the second mode. This brings about an effect that the maximum confidence value can be adaptively acquired within a range not exceeding the saturation threshold while the convergence time until convergence to the target value can be reduced.

Furthermore, in the first aspect, the exposure control unit shifts to the second mode upon converging to the target value in the first mode. This brings about an effect that exposure control can be performed with emphasis on the convergence target value.

Furthermore, in the first aspect, the exposure control unit shifts to the first mode when the exposure control falls outside a convergence region that includes the saturation threshold in the second mode. This brings about an effect that exposure control can be performed with emphasis on the convergence time until convergence to the target value.

Furthermore, in the first aspect, the exposure control unit has a third mode in which the calculation object for performing the exposure control is limited to the low modulation frequency and a margin is not provided in the saturation threshold with respect to a measurement result for the high modulation frequency. The exposure control unit uses the third mode in a case where short-distance imaging is not performed. This brings about an effect that it is possible to perform exposure control suitable for a case where short-distance imaging is not performed.

Furthermore, a second aspect of the present technology is a distance measuring device including: a light source that irradiates a measurement object with light of two modulation frequencies, a light detection unit that includes a plurality of pixels and receives reflected light based on the irradiation light of the two modulation frequencies from the light source, the reflected light coming from the measurement object, and an exposure control unit that performs exposure control to obtain a maximum confidence value for a confidence value of the reflected light within a range not exceeding a saturation threshold that serves as a saturation determination reference, with the saturation threshold used as a target, on the basis of a measurement result for each of the two modulation frequencies based on a detection output of the light detection unit. The exposure control unit sets the measurement result for one of the two modulation frequencies as a calculation object configured to perform exposure control, and sets a predetermined margin to the saturation threshold with respect to the measurement result for the other modulation frequency. As a result, the problem of computational resources can be solved, and the exposure control processing can be performed for each vertical period. This brings about an effect that the convergence time until convergence to the target value can be reduced.

### BRIEF DESCRIPTION OF DRAWINGS

FIG. 1 is a conceptual diagram of a ToF-based distance measuring system.

FIG. 2 is a block diagram illustrating an example of a system configuration of a ToF-based distance measuring device in a first embodiment of the present technology.

FIG. 3 is a block diagram illustrating an example of a configuration of a light detection unit of the distance measuring device in the first embodiment.

FIG. 4 is a circuit diagram illustrating an example of a circuit configuration of a pixel in the light detection unit of the distance measuring device in the first embodiment.

FIG. 5 is a timing waveform chart for explaining calculation of a distance in the ToF-based distance measuring device.

FIG. 6 is a diagram for explaining AE control in the first embodiment.

FIG. 7 is a diagram for explaining AE control in a second embodiment.

FIG. 8 is a flowchart illustrating an example of a processing procedure for a specific example of the AE control in the second embodiment.

FIG. 9 is a diagram illustrating an arrangement example 1, an arrangement example 2, and an arrangement example 3 of the AE calculation processing unit in a third embodiment.

FIG. 10 is a diagram illustrating an arrangement example 4 and an arrangement example 5 of the AE calculation processing unit in the third embodiment.

FIG. 11 is an external view of a smartphone according to a specific example of an electronic device of the present technology.

### MODE FOR CARRYING OUT THE INVENTION

Hereinafter, modes for carrying out the present technology (hereinafter referred to as embodiments) will be described. The description will be given in the following order.
1. ToF-based distance measuring system
2. First Embodiment (AE control: an example in which a calculation object for AE control is limited to one modulation frequency)
3. Second Embodiment (AE control: an example in which a mode emphasizing the AE convergence time and a mode emphasizing the AE convergence target value are set and changed adaptively)
4. Third Embodiment (an arrangement example of an AE calculation processing unit that performs calculation for AE control)
5. Modification example
6. Application example
7. Electronic device of the present technology (an example of a smartphone)
8. Configuration that present technology can employ

### 1. ToF-Based Distance Measuring System

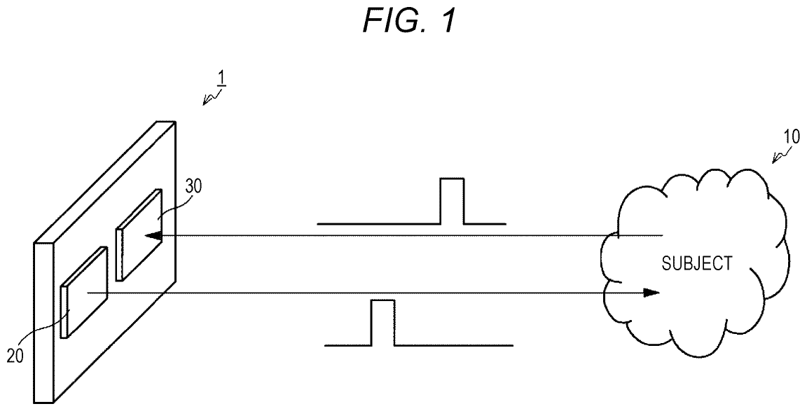

FIG. 1 is a conceptual diagram of a ToF-based distance measuring system. In the distance measuring system according to the present example, a distance measuring device 1 employs the ToF method as a measurement method for measuring a distance to a subject 10, which is a measurement object. The ToF method is a method for measuring the time taken for light emitted toward the subject 10 to be reflected by the subject 10 and return. In order to implement distance measurement by the ToF method, the distance measuring device 1 includes a light source 20 that emits light (e.g., laser light having a peak wavelength in an infrared wavelength region) to be emitted toward the subject 10, and a light detection unit 30 that includes a plurality of pixels and detects reflected light that is reflected by the subject 10 and returns.

In the ToF-based distance measuring system, a continuous wave modulation method in which a calculation result for automatic exposure control is a phase is employed, and a plurality of modulation frequencies is used. Light of a plurality of modulation frequencies is emitted from the light source 20 toward the subject 10, which is the measurement object, in a time-division manner, for example. Here, the reason why the modulation frequency of the irradiation light is plural will be described.

Phase measurement performed by a distance measuring system using a continuous wave is reset every period (2π), and hence there is an aliasing distance, which is also referred to as aliasing noise. In a case where there is one modulation frequency, the aliasing distance is the longest distance that can be measured. In contrast, in the case of using a plurality of modulation frequencies, for example, two modulation frequencies of a relatively high frequency and a relatively low frequency, when the same estimation result is obtained by measuring two phases obtained using the different modulation frequencies, the actual distance to the measurement object can be specified.

### 2. First Embodiment

### [System Configuration]

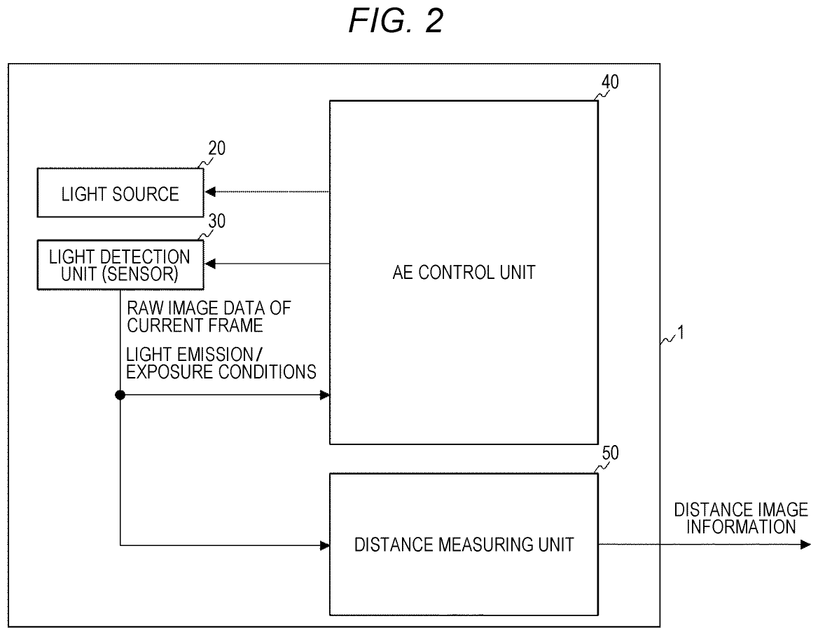

FIG. 2 is a block diagram illustrating an example of a system configuration of a ToF-based distance measuring device in a first embodiment of the present technology.

In addition to the light source 20 and the light detection unit 30, the ToF-based distance measuring device 1 in the first embodiment includes an AE control unit 40 that controls automatic exposure (AE) on the basis of a signal value output from the light detection unit 30, and a distance measuring unit 50 that calculates a distance image (depth map). Note that the AE control unit 40 is an example of an exposure control unit recited in the claims.

The ToF-based distance measuring device 1 having the configuration described above can detect distance information for each pixel of the light detection unit 30 and acquire a highly accurate distance image (depth map) in units of imaging frames.

The distance measuring device 1 in the first embodiment is an indirect ToF-based distance image sensor that measures a distance from the distance measuring device 1 to the measurement object by measuring the time-of-flight on the basis of detection of an arrival phase difference of the reflected light arriving at the light detection unit 30 from the measurement object (subject 10), which is the light emitted from the light source 20 and reflected by the measurement object.

Under the control of the AE control unit 40, the light source 20 repeats an on/off operation at a predetermined cycle to irradiate the measurement object with light. As the irradiation light of the light source 20, for example, near-infrared light around 850 nm is often used.

The light detection unit 30 receives light, which is the irradiation light that is emitted from the light source 20 and is then reflected by the measurement object and returns, and detects distance information for each pixel. From the light detection unit 30, RAW image data and light emission/exposure setting information of a current frame including the distance information detected for each pixel are output and supplied to the AE control unit 40 and the distance measuring unit 50.

The AE control unit 40 calculates light emission/exposure conditions of the next frame on the basis of the RAW image data and the light emission/exposure setting information of the current frame supplied from the light detection unit 30. The light emission/exposure conditions of the next frame are the light emission time and light emission intensity of the light source 20 and the exposure time of the light detection unit 30 at the time of acquiring the distance image of the next frame. The AE control unit 40 controls the light emission time and the light emission intensity of the light source 20 of the next frame and the exposure time of the light detection unit 30 on the basis of the calculated light emission/exposure conditions of the next frame.

The distance measuring unit 50 calculates a distance image by performing calculations using the RAW image data of the current frame, which includes the distance information detected for each pixel of the light detection unit 30. The distance measuring unit 50 then outputs the distance image to the outside of the distance measuring device 1 as distance image information including depth information, which is information regarding depth, and confidence value information, which is light reception information. Here, the distance image is, for example, an image in which a distance value (depth/depth value) based on the distance information detected for each pixel is reflected in each pixel.

### [Configuration Example of Light Detection Unit]

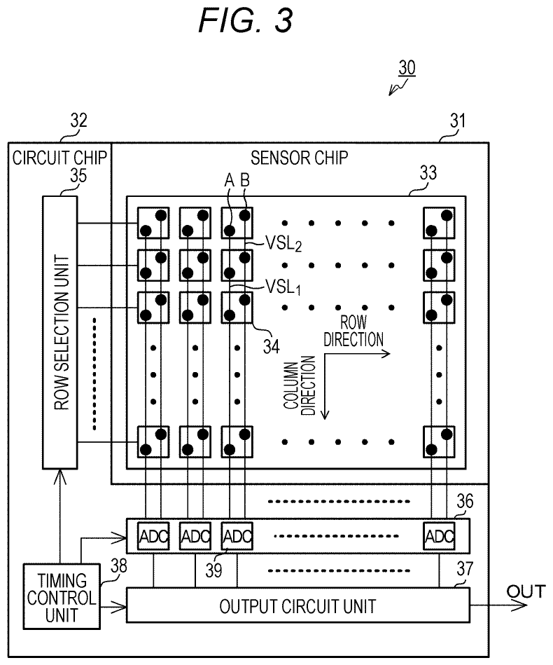

Here, a specific configuration example of the light detection unit 30 of the distance measuring device in the first embodiment will be described with reference to FIG. 3. FIG. 3 is a block diagram illustrating an example of the configuration of the light detection unit 30.

The light detection unit 30 has a stacked structure including a sensor chip 31 and a circuit chip 32 stacked on the sensor chip 31. In this stacked structure, the sensor chip 31 and the circuit chip 32 are electrically connected through a connection portion such as a via or Cu—Cu bonding (not illustrated). Note that FIG. 3 illustrates a state in which the wiring of the sensor chip 31 and the wiring of the circuit chip 32 are electrically connected through the connection portion described above.

A pixel array unit 33 is formed on the sensor chip 31. The pixel array unit 33 includes a plurality of pixels 34 arranged in a matrix shape (an array shape) in a two-dimensional grid pattern on the sensor chip 31. In the pixel array unit 33, each of the plurality of pixels 34 receives incident light (e.g., near-infrared light), performs photoelectric conversion, and outputs an analog pixel signal. In the pixel array unit 33, two vertical signal lines VSL₁ and VSL₂ are wired for each pixel column. When the number of pixel columns of the pixel array unit 33 is M (M is an integer), (2×M) vertical signal lines VSL (VSL₁, VSL₂) in total are wired in the pixel array unit 33.

Each of the plurality of pixels 34 has a first tap A and a second tap B (details thereof will be described later). An analog pixel signal AIN_{P1} based on the charge of the first tap A of the pixel 34 in the corresponding pixel column is output to one vertical signal line VSL₁, of the two vertical signal lines VSL₁ and VSL₂. Furthermore, an analog pixel signal AIN_{P2} based on the charge of the second tap B of the pixel 34 in the corresponding pixel column is output to the other vertical signal line VSL₂. The analog pixel signals AIN_{P1} and AIN_{P2} will be described later.

On the circuit chip 32, a row selection unit 35, a column signal processing unit 36, an output circuit unit 37, and a timing control unit 38 are disposed.

The row selection unit 35 drives each pixel 34 of the pixel array unit 33 in units of pixel rows and outputs analog pixel signals AIN_{P1} and AIN_{P2}. Under the driving by the row selection unit 35, the analog pixel signals AIN_{P1} and AIN_{P2} output from the pixel 34 in the selected row are supplied to the column signal processing unit 36 through the two vertical signal lines VSL₁ and VSL₂.

The column signal processing unit 36 includes a plurality of analog-to-digital converters (ADC) 39 provided corresponding to the pixel columns of the pixel array unit 33, for example, one ADC per pixel column. The analog-digital converter 39 performs analog-digital conversion processing on the analog pixel signals AIN_{P1} and AIN_{P2} supplied through the vertical signal lines VSL₁ and VSL₂, and supplies the processed signals to the output circuit unit 37.

The output circuit unit 37 performs predetermined signal processing such as correlated double sampling (CDS) processing on the digitized pixel signals AIN_{P1} and AIN_{P2} output from the column signal processing unit 36, and outputs the pixel signals AIN_{P1} and AIN_{P2} to the outside of the circuit chip 32.

The timing control unit 38 generates various timing signals, clock signals, control signals, and the like, and performs drive control of the row selection unit 35, the column signal processing unit 36, the output circuit unit 37, and the like on the basis of these signals.

### [Example of Pixel Circuit Configuration]

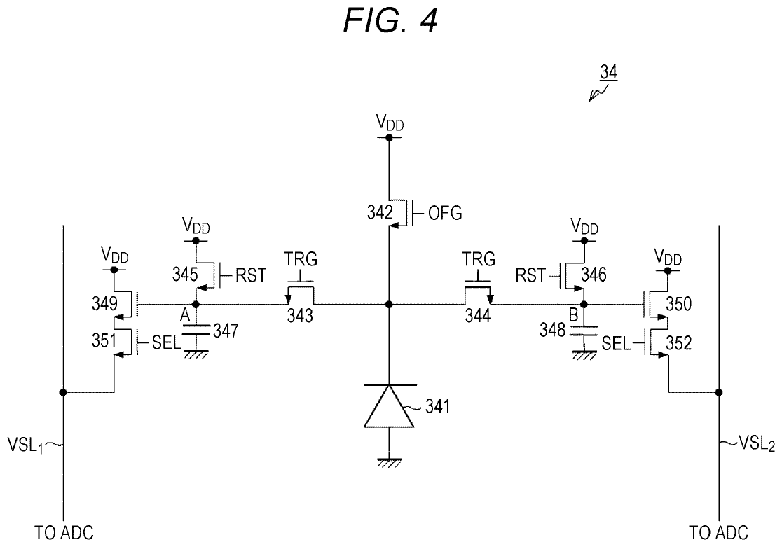

FIG. 4 is a circuit diagram illustrating an example of the circuit configuration of the pixel 34 in the light detection unit 30 of the distance measuring device in the first embodiment.

The pixel 34 according to the present example includes, for example, a PN-junction photodiode (PD) 341 as a photoelectric conversion unit. In addition to the photodiode 341, the pixel 34 includes an overflow transistor 342, two transfer transistors 343 and 344, two reset transistors 345 and 346, two floating diffusion layers 347 and 348, two amplification transistors 349 and 350, and two selection transistors 351 and 352. The two floating diffusion layers 347 and 348 correspond to the first and second taps A and B (hereinafter, these may be simply described as “taps A and B”) illustrated in FIG. 3 described above.

The photodiode 341 has an anode electrode grounded, and photoelectrically converts the received light to generate a charge. The photodiode 341 can have, for example, a back irradiation-type pixel structure that captures light emitted from the back side of a substrate. However, the pixel structure is not limited to the back irradiation-type pixel structure, and may be a front irradiation-type pixel structure that captures light emitted from the front side of the substrate.

The overflow transistor 342 is connected between a cathode electrode of the photodiode 341 and a power source line of a power supply voltage V_{DD}, and has a function of resetting the photodiode 341. Specifically, the overflow transistor 342 becomes conductive in response to an overflow gate signal OFG supplied from the row selection unit 35, thereby sequentially discharging the charge of the photodiode 341 to the power source line of the power supply voltage V_{DD}.

The two transfer transistors 343 and 344 are connected between the cathode electrode of the photodiode 341 and the respective two floating diffusion layers 347 and 348 (taps A and B). Then, the transfer transistors 343 and 344 become conductive in response to transfer signals TRG supplied from the row selection unit 35, thereby sequentially transferring the charge photoelectrically converted by the photodiode 341 to the floating diffusion layers 347 and 348.

The floating diffusion layers 347 and 348 corresponding to the first and second taps A and B accumulate the charge transferred from the photodiode 341, convert the charge into voltage signals with voltage values corresponding to the amounts of charge accumulated, and generate analog pixel signals AIN_{P1} and AIN_{P2}.

The two reset transistors 345 and 346 are connected between the respective two floating diffusion layers 347 and 348 and the power source line of the power supply voltage V_{DD}. Then, the reset transistors 345 and 346 become conductive in response to reset signals RST supplied from the row selection unit 35, thereby extracting the charge from the floating diffusion layers 347 and 348 and initializing the amounts of charge.

The two amplification transistors 349 and 350 are connected between the power source line of the power supply voltage V_{DD} and the respective two selection transistors 351 and 352, and amplify the voltage signals converted from the charge to the voltages in the floating diffusion layers 347 and 348, respectively.

The two selection transistors 351 and 352 are connected between the respective two amplification transistors 349 and 350 and the respective vertical signal lines VSL₁ and VSL₂. Then, the selection transistors 351 and 352 become conductive in response to selection signals SEL supplied from the row selection unit 35, thereby outputting the voltage signals amplified by the amplification transistors 349 and 350 to the two vertical signal lines VSL₁ and VSL₂ as the analog pixel signals AIN_{P1} and AIN_{P2}.

The two vertical signal lines VSL₁ and VSL₂ are connected to the input ends of one analog-digital converter 39 in the column signal processing unit 36 for each pixel column, and transmit the analog pixel signals AIN_{P1} and AIN_{P2} output from the pixels 34 for each pixel column to the analog-digital converter 39.

Note that the circuit configuration of the pixel 34 is not limited to the circuit configuration illustrated in FIG. 3 as long as the circuit configuration may generate the analog pixel signals AIN_{P1} and AIN_{P2} by photoelectric conversion.

### [Distance Calculation by ToF Method]

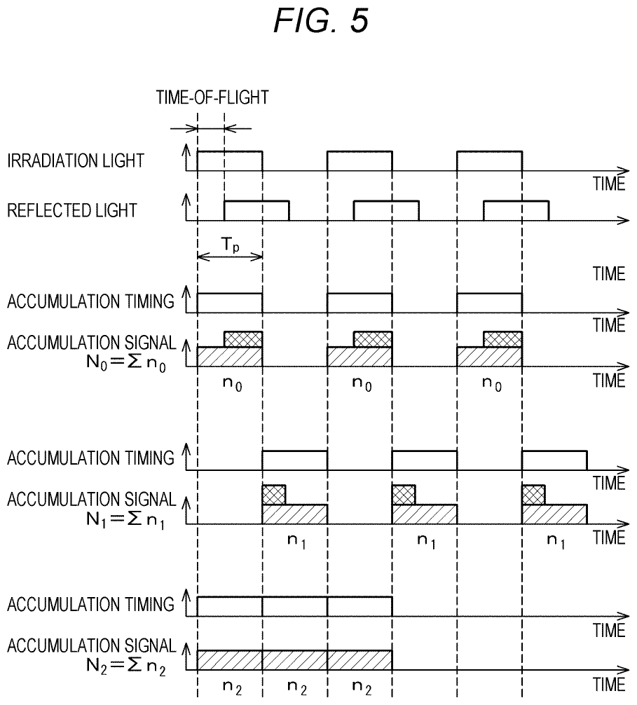

Here, the distance calculation by the ToF method will be described with reference to FIGS. 4 and 5. FIG. 5 is a timing waveform chart for explaining the distance calculation in the ToF-based distance measuring device 1. The light source 20 and the light detection unit 30 in the ToF-based distance measuring device 1 each operate at the timing illustrated in the timing waveform chart of FIG. 5.

The light source 20 irradiates the measurement object with light for a predetermined period, for example, a period of pulse light emission time Tₚ under the control of the AE control unit 40. The irradiation light emitted from the light source 20 is reflected by the measurement object and returns. This reflected light (active light) is received by the photodiode 341. The time from the start of irradiating the measurement object with the irradiation light to the reception of the reflected light by the photodiode 341, that is, the time-of-flight, corresponds to the distance from the distance measuring device 1 to the measurement object.

In FIG. 5 the photodiode 341 receives the reflected light from the measurement object only during the period of the pulse light emission time Tₚ from a time point at which the irradiation with the irradiation light is started. At this time, the light received by the photodiode 341 includes not only reflected light (active light), the light that is emitted toward the measurement object and is then reflected by the measurement object and returns, but also ambient light reflected/scattered by an object, the atmosphere, or the like.

When light reception is performed once, charge photoelectrically converted by the photodiode 341 is transferred to and accumulated in the tap A (floating diffusion layer 347). Then, a signal no of a voltage value corresponding to the amount of charge accumulated in the floating diffusion layer 347 is acquired from the tap A. At a time point when the accumulation timing for the tap A ends, the charge photoelectrically converted by the photodiode 341 is transferred to and accumulated in the tap B (floating diffusion layer 348). Then, a signal n₁ of a voltage value corresponding to the amount of charge accumulated in the floating diffusion layer 348 is acquired from the tap B.

As described above, driving in which the phases of the accumulation timings are made different from each other by 180 degrees (driving in which the phases are completely reversed) is performed on the tap A and the tap B, so that the signal no and the signal n₁ are acquired, respectively. Then, such driving is repeated a plurality of times to accumulate and integrate the signals n₀ and n₁, resulting in the acquisition of accumulation signals N₀ and N₁, respectively.

For example, for one pixel 34, light reception is performed twice in one phase, and signals are accumulated four times, that is, at 0 degrees, 90 degrees, 180 degrees, and 270 degrees, in each of the tap A and tap B. A distance D from the distance measuring device 1 to the measurement object is calculated on the basis of the accumulation signals N₀ and N₁ acquired in this manner.

Each of the accumulation signals N₀ and N₁ includes not only a component of the reflected light (active light) that is reflected by the measurement object and returns, but also a component of the ambient light reflected/scattered by an object, the atmosphere, or the like. Therefore, in the operation described above, in order to remove the influence of the component of the ambient light and leave the component of the reflected light (active light), signals n₂ based on the ambient light are also accumulated and integrated to acquire an accumulation signal N₂ for the ambient light component.

Using the accumulation signals N₀ and N₁, which include the ambient light component, and the accumulation signal N₂ for the ambient light component, all acquired in the above manner, the distance D from the distance measuring device 1 to the measurement object can be calculated through computational processing based on the following Equations 1 and 2.

$$[ Math . 1 ]$$

$$Δϕ = \frac{{N}_{0} - {N}_{2}}{{N}_{0} + {N}_{1} - 2 \cdot {N}_{2}} \qquad Equation 1$$

$$[ Math . 2 ]$$

$$D = \frac{c \cdot {T}_{p}}{2} ( 1 - \frac{Δϕ}{2 π} ) \qquad Equation 2$$

In the above equations (1) and (2), D represents the distance from the distance measuring device 1 to the measurement object, c represents the speed of light, and Tₚ represents the pulse light emission time.

The distance measuring unit 50 illustrated in FIG. 2 uses the accumulation signals N₀ and N₁, which include the ambient light component, and the accumulation signal N₂ for the ambient light component to calculate the distance D from the distance measuring device 1 to the measurement object through the computational processing based on the above Equations 1 and 2 output from the light detection unit 30, and outputs the distance D as distance image information. Examples of the distance image information may include image information obtained by coloring the image with a density that corresponds to the distance D. Note that, although the calculated distance D is output as the distance image information here, the calculated distance D may be output as it is as the distance information.

### [Basic AE Control]

The ToF-based distance measuring device 1 described above can be used by being installed in an electronic device having a camera function, for example, a mobile device such as a smartphone, a digital camera, a tablet, or a personal computer. In the distance measuring device 1, in order to acquire a high-quality distance image, under the control of the AE control unit 40, control is performed to obtain the maximum confidence value for a confidence value (Confidence) of the reflected light from the measurement object within a range not exceeding a saturation threshold that serves as a saturation determination reference, with the saturation threshold (saturation determination threshold) as a target, on the basis of measurement results for a plurality of modulation frequencies based on the detection output of the light detection unit 30.

Here, the “confidence value of the reflected light” is one type of the light reception information of the light detection unit 30, and is a value representing the amount (degree) of the reflected light, which is the irradiation light that is emitted from the light source 20 toward the measurement object (subject) and is then reflected by the measurement object and returns to the light detection unit 30.

As described above, in the AE control of the distance measuring device 1, control is performed to obtain the maximum confidence value within a range not exceeding the saturation threshold. During the control, a process of checking whether the confidence value exceeds the saturation threshold is performed for each pixel 34 of the light detection unit 30. However, when the process of checking whether the confidence value exceeds the saturation threshold is performed for each pixel 34, the calculation time for AE control may exceed one vertical period in a case where computational resources are insufficient.

Then, when the calculation time for AE control exceeds one vertical period, the AE control processing is performed only once in a plurality of vertical periods, rather than every vertical period. As a result, a problem arises that the time taken for the confidence value to converge to the target value extends.

In particular, in the ToF-based distance measuring system, in the distance measuring device 1 using a plurality of modulation frequencies, for example, two modulation frequencies of a high frequency and a low frequency, calculation for AE control is required for each measurement result of each of the high frequency and the low frequency. This often results in calculation time exceeding one vertical period.

### [AE Control in First Embodiment]

Therefore, in the distance measuring device 1 in the first embodiment, under the control of the AE control unit 40, when the plurality of modulation frequencies is two modulation frequencies, control is performed to set the measurement result for one of the two modulation frequencies as the calculation object for the AE, and set a predetermined margin (allowable range) to the saturation threshold for the measurement result for the other modulation frequency. The predetermined margin can be arbitrarily set.

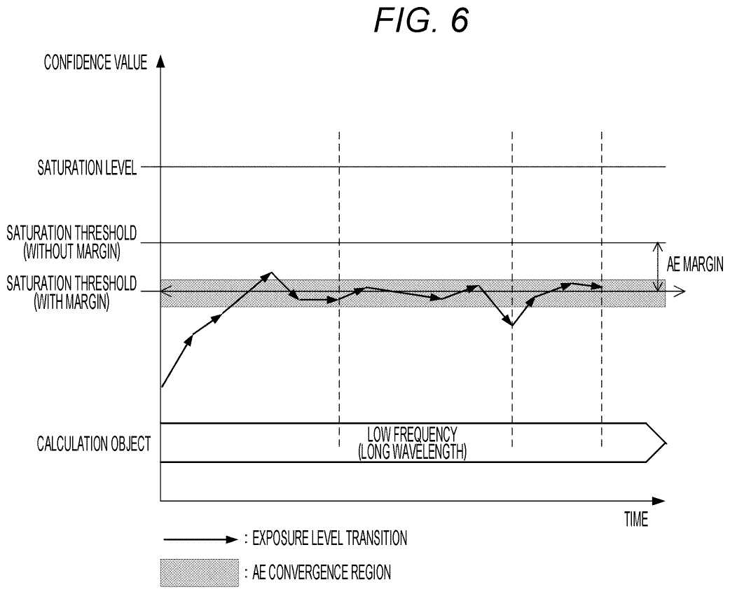

Here, when the two modulation frequencies are a modulation frequency of a relatively low frequency and a modulation frequency of a relatively high frequency, it is preferable to take one modulation frequency as a low modulation frequency and the other modulation frequency as a high modulation frequency. Thus, as illustrated in FIG. 6, control is performed to set the measurement result for the low modulation frequency as the calculation object for AE control, and set a predetermined margin to the saturation threshold for the measurement result for the high modulation frequency.

FIG. 6 is a diagram for explaining AE control in the first embodiment. In FIG. 6, a line with an arrow represents an exposure level transition, and a shaded region represents an AE convergence region. In addition, the saturation threshold is set in the vicinity of the exposure target value. In other words, the exposure target value is set in the vicinity of the saturation threshold.

As described above, by limiting the calculation object for AE control to the measurement result for one of the two modulation frequencies, the calculation time for AE control can be reduced even when it is checked whether the confidence value does not exceed the saturation threshold for each pixel 34 of the light detection unit 30. Specifically, the calculation time can be reduced to about half of the calculation time in a case where the measurement results of both of the two modulation frequencies are set calculation objects for AE control. This makes it possible to solve the problem of computational resources and perform the AE control processing for each vertical period, thereby reducing the AE convergence time.

Furthermore, by using a low modulation frequency with a long wavelength as the modulation frequency that limits the calculation object for AE control, a large signal can be obtained, particularly in a case where distance measurement is performed on a measurement object existing at a short distance, achieving a wide measurement range without ambiguity. Moreover, by setting a predetermined margin to the saturation threshold with respect to the measurement result for the high modulation frequency, it is possible to prevent overexposure (increase in saturation region) on the short-wavelength high modulation frequency side with respect to the calculation result based on the measurement result for the low modulation frequency at the time of distance measurement at a short distance (at the time of short-distance imaging).

### 3. Second Embodiment

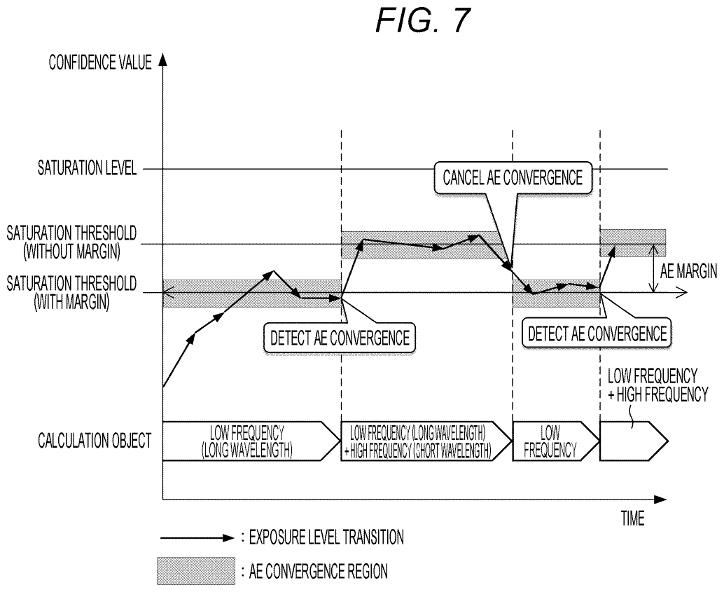

A second embodiment of the present technology is an example in which a first mode emphasizing the AE convergence time and a second mode emphasizing the AE convergence target value are provided, and these modes are changed adaptively (used selectively). AE control in the second embodiment will be described with reference to FIG. 7. FIG. 7 is a diagram for explaining the AE control in the second embodiment. Note that the overall configuration of the distance measuring device 1 is similar to that of the first embodiment described above, and hence the detailed description thereof is omitted.

In FIG. 7, a line with an arrow represents an exposure level transition, and a shaded region represents an AE convergence region. In FIG. 7, the AE convergence is determined in a case where the exposure level transition continuously enters the AE convergence region over a plurality of vertical periods. A plurality of vertical periods serving as a reference for determining whether or not the AE convergence region has been entered can be arbitrarily set.

In the AE control in the second embodiment, first, a calculation object for AE control is limited to a low modulation frequency with a long wavelength, and a first mode is set in which a predetermined margin is provided in a saturation threshold with respect to a measurement result for the high modulation frequency. As in the case of the first embodiment, since the AE control processing can be performed for each vertical period, it can be said that the first mode is a mode emphasizing the AE convergence time in which the AE convergence time can be reduced.

In the first mode emphasizing the AE convergence time, saturation of exposure can be prevented. However, by providing a predetermined margin in the saturation threshold, the AE convergence target value is lowered by the margin, raising a concern that an optimum exposure time may not be settable for the AE control. Therefore, when the AE convergence is determined in the first mode emphasizing the AE convergence time, a saturation threshold without a margin is set as a target, and the calculation object for AE control is shifted to the second mode in which the AE control is performed as the low modulation frequency with the long wavelength and the high modulation frequency with the short wavelength. This second mode can be said to be a mode emphasizing the AE convergence target value because control is performed with the saturation threshold without a margin, which is closer to the saturation level, as a target.

In the second mode emphasizing the AE convergence target value, when the AE convergence region (shaded region) is deviated and the AE convergence is canceled, in order to reduce the AE convergence time, the mode is again shifted to the first mode emphasizing the AE convergence time in which the calculation object for AE control is limited to the low modulation frequency with the long wavelength, and the AE control is performed by providing a margin in the saturation threshold for the measurement result for the high modulation frequency. In the first mode emphasizing the AE convergence time, when the AE convergence is detected, the saturation threshold without a margin is set as a target, and the mode is shifted to the second mode emphasizing the AE convergence target value in which the AE control is performed, setting each of the low modulation frequency with the long wavelength and the high modulation frequency with the short wavelength as the calculation object for AE control.

As described above, in the AE control in the second embodiment, the AE convergence target value is different for each modulation frequency set as the calculation object for the AE control, and a plurality of saturation thresholds, specifically, a saturation threshold without a margin and a saturation threshold with a margin are adaptively used as the AE convergence target value. With this control, it is possible to reduce the calculation time for AE control to up to half, thereby solving the problem of computational resources. In addition, it is possible to acquire the maximum confidence value adaptively within a range not exceeding the saturation threshold while reducing the AE convergence time.

In the example described above, two modes have been set for the AE control mode: the first mode in which the calculation object for AE control is limited to the low modulation frequency and a margin is provided in the saturation threshold for the measurement result for the high modulation frequency, and the second mode in which each of the low modulation frequency and the high modulation frequency is set as the calculation object for the AE mode. However, the number of modes can be further increased. Specifically, three modes are set by adding, to the two modes described above, a third mode in which the calculation object for AE control is limited to the low modulation frequency, and a margin is not provided in the saturation threshold for the measurement result for the high modulation frequency.

The first mode is a mode emphasizing the AE convergence time in which convergence is first performed in a short time, even with insufficient convergence accuracy, in a situation where the AE has not converged. The second mode is a mode emphasizing the AE convergence target value in which the convergence accuracy is further improved after the AE convergence. In contrast, the third mode is a mode suitable for use in a case where short-distance imaging (distance measurement at a short distance) is not performed.

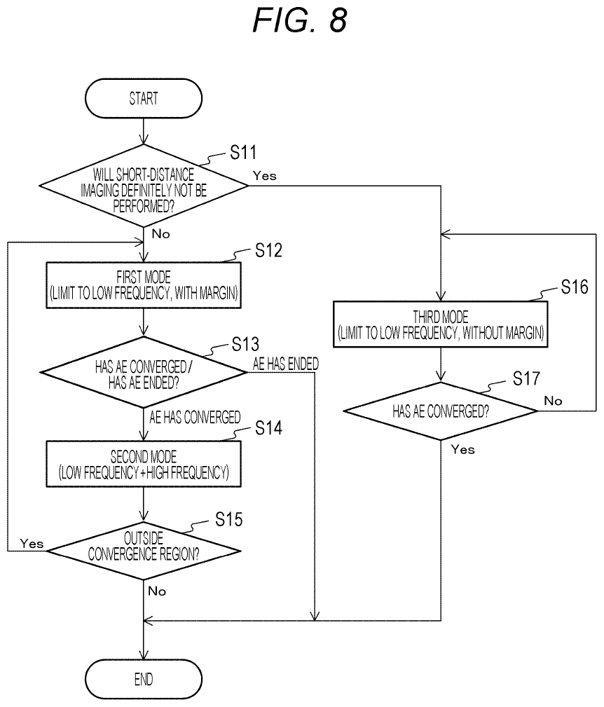

A specific example of the AE control in the second embodiment using the first mode, the second mode, and the third mode will be described below with reference to FIG. 8. FIG. 8 is a flowchart illustrating an example of a processing procedure for the specific example of the AE control in the second embodiment. This processing is executed under the control of the AE control unit 40.

When the AE control is started, the AE control unit 40 first determines whether short-distance imaging will definitely not be performed (step S11). It can be determined whether short-distance imaging will definitely not be performed, from information such as the camera's scene setting (e.g., landscape mode) and the type of application (e.g., identification photograph application).

In a case where the AE control unit 40 determines that short-distance imaging will definitely not be performed (No in S11), the process for the first mode, that is, the mode in which the calculation object for AE control is limited to the low modulation frequency and a margin is provided in the saturation threshold for the measurement result for the high modulation frequency, is executed until the confidence value converges to the target value (step S12).

After the process of step S12, the AE control unit 40 determines whether the AE control has converged or the AE control has ended (step S13), and when the AE control has ended (AE end in S13), a series of processes for AE control is ended.

When the AE control has converged, that is, the confidence value has converged to the target value (AE convergence in S13), the AE control unit 40 shifts to the second mode, that is, a mode in which each of the low modulation frequency and the high modulation frequency is set as the calculation object for AE control, and executes the process for the mode (step S14).

Next, in the process for the second mode, the AE control unit 40 determines whether or not the AE control deviates from the AE convergence region (shaded region in FIG. 7) (step S15). When the AE control does not deviate from the AE convergence region (No in S15), the AE control is ended. When the AE control deviates from the AE convergence region (Yes in S15), the process returns to step S12, and the process for the first mode is executed again.

In the process of step S11, in a case where the AE control unit 40 determines that short-distance imaging will definitely not be performed (Yes in S11), the process is executed for the third mode, that is, a mode suitable for use in a case where the short-distance imaging (distance measurement at a short distance) is not performed (step S16). Accordingly, it is possible to perform AE control suitable for a case where short-distance imaging (distance measurement at a short distance) is not performed.

Next, the AE control unit 40 determines whether or not the AE control has converged in the process for the third mode (step S17). When the AE control has not converged (No in S17), the process returns to step S16 to execute the process for the third mode. When the AE control has converged (Yes in S17), the AE control is ended.

By executing the series of processes for AE control described above, the calculation time for AE control can be reduced to up to half, thereby solving the problem of computational resources. In addition, it is possible to acquire the maximum confidence value adaptively within a range not exceeding the saturation threshold while reducing the AE convergence time.

### 4. Third Embodiment

A third embodiment of the present technology is an arrangement example of an AE calculation processing unit when a functional unit that performs calculation for AE control is the AE calculation processing unit in the AE control unit 40 illustrated in FIG. 2.

In the third embodiment, a semiconductor chip (semiconductor substrate) on which the light source 20 and the light detection unit 30 illustrated in FIG. 2 are formed is defined as a sensor chip 61, and a semiconductor chip on which the AE control unit 40 illustrated in FIG. 2 is formed is defined as a circuit chip 62. In addition, an AE calculation processing unit that performs calculation when a calculation object for AE control is a low modulation frequency is referred to as an AE calculation processing unit 41A, and an AE calculation processing unit that performs calculation when a calculation object for AE control is a low modulation frequency and a high modulation frequency is referred to as an AE calculation processing unit 41B.

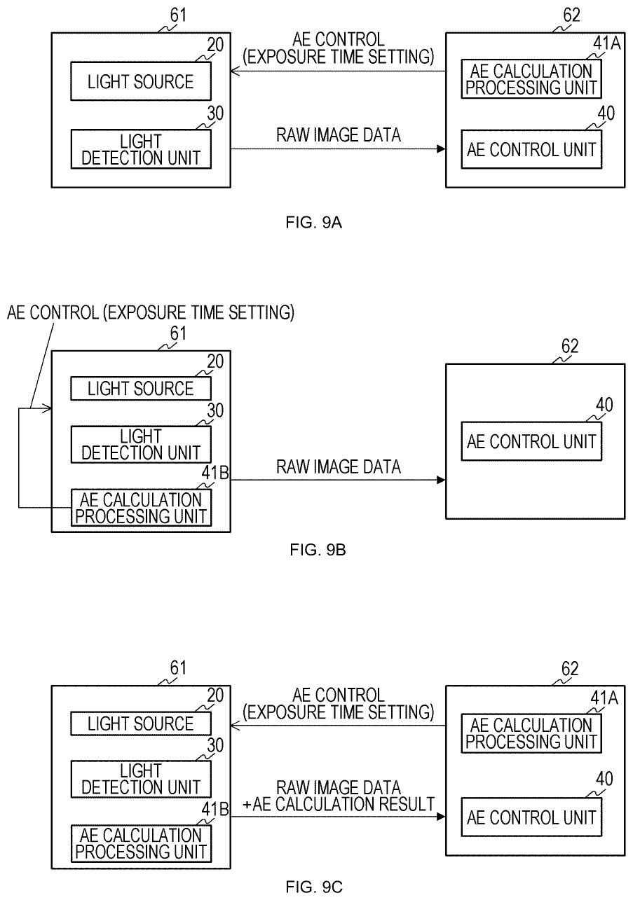

Arrangement Example 1, Arrangement Example 2, and Arrangement Example 3 of the AE calculation processing unit are illustrated in a, b, and c of FIG. 9. Arrangement Example 1 is an example in which the AE calculation processing unit 41A that performs calculation when the calculation object is the low modulation frequency is disposed on the circuit chip 62, and AE control for setting the exposure time is performed on the sensor chip 61 from the circuit chip 62 side. Arrangement Example 2 is an example in which the AE calculation processing unit 41B that performs calculation when the calculation object is the low modulation frequency and the high modulation frequency is disposed on the sensor chip 61, and AE control is performed on the sensor chip 61. Arrangement Example 3 is an example in which the AE calculation processing unit 41A is disposed on the circuit chip 62, the AE calculation processing unit 41B is disposed on the sensor chip 61, the AE calculation result of the AE calculation processing unit 41B is transmitted to the circuit chip 62, and the AE control is performed on the sensor chip 61 from the circuit chip 62 side.

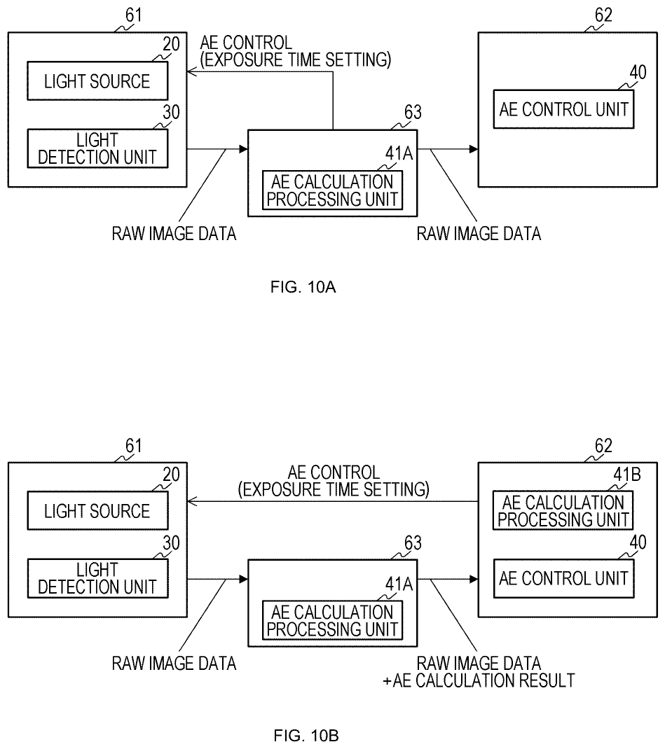

Arrangement Example 4 and Arrangement Example 5 of the AE calculation processing unit are illustrated in a and b of FIG. 10. Arrangement Example 4 and Arrangement Example 5 are examples in which a companion chip 63 is included in addition to the sensor chip 61 and the circuit chip 62. Arrangement Example 4 is an example in which the AE calculation processing unit 41A that performs calculation when the calculation object is the low modulation frequency is disposed on the companion chip 63, and AE control is performed on the sensor chip 61 from the companion chip 63 side. Arrangement Example 5 is an example in which the AE calculation processing unit 41A is disposed on the companion chip 63, the AE calculation processing unit 41B is disposed on the circuit chip 62, the AE calculation result of the AE calculation processing unit 41A is transmitted to the circuit chip 62, and the AE control is performed on the sensor chip 61 from the circuit chip 62 side.

As described above, the chip arrangement of the AE calculation processing units 41A and 41B that perform calculations for AE control is not limited, and various chip arrangements can be employed.

### 5. Modification Example

Note that the embodiments described above show examples for embodying the present technology, and the matters in the embodiments and the matters specifying the invention in the claims have corresponding relationships, respectively. Similarly, the matters specifying the invention in the claims and matters with the same names in the embodiments of the present technology have correspondence relationships, respectively. However, the present technology is not limited to the embodiments, and can be embodied by applying various modifications to the embodiments without departing from the gist of the present technology.

### 6. Application Example

In each of the embodiments described above, a case where the distance measuring device of the present technology is used as the means to acquire a distance image (depth map) has been described as an example. However, the distance measuring device of the present technology is not only used as the means to acquire a distance image, but can be applied to autofocusing, which is to adjust the focus automatically.

### 7. Electronic Device of Present Technology

The distance measuring device according to each of the embodiments of the present technology described above can be used as a distance measuring device installed in various electronic devices. Examples of the electronic device in which the distance measuring device is installed may include mobile devices such as a smartphone, a digital camera, a tablet, and a personal computer can be exemplified. However, the present invention is not limited to the mobile device. Here, a smartphone is used as a specific example of an electronic device (an electronic device of the present technology) in which the distance measuring device of the present technology can be installed.

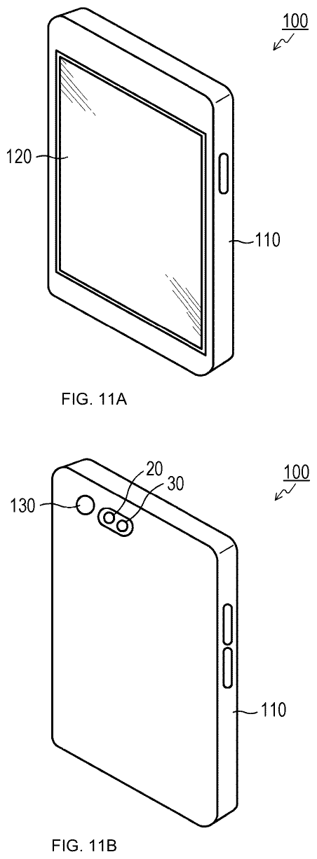

An external view of the smartphone according to the specific example of the electronic device of the present technology as viewed from the front side is illustrated in a of FIG. 11, and an external view thereof as viewed from the back side is illustrated in b of FIG. 11. A smartphone 100 according to the present specific example includes a display unit 120 on the front side of a housing 110. Furthermore, the smartphone 100 includes, for example, an imaging unit 130 in an upper portion on the back side of the housing 110.

The distance measuring device 1 according to the first or second embodiment of the present technology described above can be used by being installed in, for example, the smartphone 100, which is an example of a mobile device having the above configuration. In this case, the light source 20 and the light detection unit 30 of the distance measuring device 1 can be arranged in the vicinity of the imaging unit 130, for example, as illustrated in b of the figure. However, the arrangement example of the light source 20, the light detection unit 30, and the imaging unit 130 illustrated in b of the figure is an example, and is not limited to this arrangement example.

As described above, the smartphone 100 according to the present specific example is manufactured by installing therein the distance measuring device 1 according to the first or second embodiment of the present technology. Then, by the installation of the distance measuring device 1, the smartphone 100 according to the specific example can be used for a device with limited computational resources and can acquire the maximum confidence value within a range not exceeding the saturation threshold while reducing the AE convergence time, thereby acquiring a good distance image (depth map).

### 8. Configuration that Present Technology can Employ

Note that the present technology may also have the following configuration.
(1) A distance measuring device including:
a light source that irradiates a measurement object with light of two modulation frequencies;
a light detection unit that includes a plurality of pixels and receives reflected light based on the irradiation light of the two modulation frequencies from the light source, the reflected light coming from the measurement object; and
an exposure control unit that performs exposure control to obtain a maximum confidence value for a confidence value of the reflected light within a range not exceeding a saturation threshold that serves as a saturation determination reference, with the saturation threshold used as a target, on the basis of a measurement result for each of the two modulation frequencies based on a detection output of the light detection unit,
in which the exposure control unit sets the measurement result for one of the two modulation frequencies as a calculation object for performing exposure control, and sets a predetermined margin to the saturation threshold with respect to the measurement result for the other modulation frequency.
(2) The distance measuring device according to (1) above, in which
the one modulation frequency is a low modulation frequency, and
the other modulation frequency is a high modulation frequency.
(3) The distance measuring device according to (2) above, in which
the exposure control unit has a first mode in which the calculation object for performing the exposure control is limited to the low modulation frequency and a predetermined margin is provided in the saturation threshold with respect to a measurement result for the high modulation frequency, and a second mode in which the exposure control is performed, setting the saturation threshold without a margin as a target and setting each of the low modulation frequency and the high modulation frequency as the calculation object for performing the exposure control, and the exposure control unit selectively uses the first mode and the second mode.
(4) The distance measuring device according to (3) above, in which
the exposure control unit shifts to the second mode when the exposure control converges in the first mode.
(5) The distance measuring device according to (4) above, in which
the exposure control unit shifts to the first mode when the exposure control falls outside a convergence region that includes the saturation threshold in the second mode.
(6) The distance measuring device according to (3) above, in which
the exposure control unit has a third mode in which the calculation object for performing the exposure control is limited to the low modulation frequency and a margin is not provided in the saturation threshold with respect to a measurement result for the high modulation frequency, and the exposure control unit uses the third mode in a case where short-distance imaging is not performed.
(7) An electronic device including a distance measuring device that includes
a light source that irradiates a measurement object with light of two modulation frequencies,
a light detection unit that includes a plurality of pixels and receives reflected light based on the irradiation light of the two modulation frequencies from the light source, the reflected light coming from the measurement object, and
an exposure control unit that performs exposure control to obtain a maximum confidence value for a confidence value of the reflected light within a range not exceeding a saturation threshold that serves as a saturation determination reference, with the saturation threshold used as a target, on the basis of a measurement result for each of the two modulation frequencies based on a detection output of the light detection unit,
in which the exposure control unit sets the measurement result for one of the two modulation frequencies as a calculation object configured to perform exposure control, and sets a predetermined margin to the saturation threshold with respect to the measurement result for the other modulation frequency.

### REFERENCE SIGNS LIST

1 Distance measuring device
10 Subject (measurement object)
20 Light source
30 Light detection unit
31 Sensor chip
32 Circuit chip
33 Pixel array unit
34 Pixel
35 Row selection unit
36 Column signal processing unit
37 Output circuit unit
38 Timing control unit
40 AE control unit
41A, 41B AE calculation processing unit
50 Distance measuring unit

1. A distance measuring device comprising:
a light source that irradiates a measurement object with light of two modulation frequencies;
a light detection unit that includes a plurality of pixels and receives reflected light based on the irradiation light of the two modulation frequencies from the light source, the reflected light coming from the measurement object; and
an exposure control unit that performs exposure control to obtain a maximum confidence value for a confidence value of the reflected light within a range not exceeding a saturation threshold that serves as a saturation determination reference, with the saturation threshold used as a target, on a basis of a measurement result for each of the two modulation frequencies based on a detection output of the light detection unit,
wherein the exposure control unit sets the measurement result for one of the two modulation frequencies as a calculation object for performing exposure control, and sets a predetermined margin to the saturation threshold with respect to the measurement result for the other modulation frequency.

2. The distance measuring device according to claim 1, wherein
the one modulation frequency is a low modulation frequency, and
the other modulation frequency is a high modulation frequency.

3. The distance measuring device according to claim 2, wherein
the exposure control unit has a first mode in which the calculation object for performing the exposure control is limited to the low modulation frequency and a predetermined margin is provided in the saturation threshold with respect to a measurement result for the high modulation frequency, and a second mode in which the exposure control is performed, setting the saturation threshold without a margin as a target and setting each of the low modulation frequency and the high modulation frequency as the calculation object for performing the exposure control, and the exposure control unit selectively uses the first mode and the second mode.

4. The distance measuring device according to claim 3, wherein
the exposure control unit shifts to the second mode when the exposure control converges in the first mode.

5. The distance measuring device according to claim 4, wherein
the exposure control unit shifts to the first mode when the exposure control falls outside a convergence region that includes the saturation threshold in the second mode.

6. The distance measuring device according to claim 3, wherein
the exposure control unit has a third mode in which the calculation object for performing the exposure control is limited to the low modulation frequency and a margin is not provided in the saturation threshold with respect to a measurement result for the high modulation frequency, and the exposure control unit uses the third mode in a case where short-distance imaging is not performed.

7. An electronic device comprising a distance measuring device that includes
a light source that irradiates a measurement object with light of two modulation frequencies,
a light detection unit that includes a plurality of pixels and receives reflected light based on the irradiation light of the two modulation frequencies from the light source, the reflected light coming from the measurement object, and
an exposure control unit that performs exposure control to obtain a maximum confidence value for a confidence value of the reflected light within a range not exceeding a saturation threshold that serves as a saturation determination reference, with the saturation threshold used as a target, on a basis of a measurement result for each of the two modulation frequencies based on a detection output of the light detection unit,
wherein the exposure control unit sets the measurement result for one of the two modulation frequencies as a calculation object configured to perform exposure control, and sets a predetermined margin to the saturation threshold with respect to the measurement result for the other modulation frequency.
